(19) United States
(12) Patent Application Publication
(10) Pub. No.: US 2025/0043083 A1
(43) Pub. Date: Feb. 6, 2025

(54) REINFORCED DOUBLE-THREADED SLIDE-RING NETWORKS FOR ACCELERATED HYDROGEL DISCOVERY AND 3D-PRINTING

(71) Applicant: Trustees of Dartmouth College, Hanover, NH (US)

(72) Inventors: Chenfeng Ke, St. Louis, MO (US); Miao Tang, Medway, MA (US)

(73) Assignee: Trustees of Dartmouth College, Hanover, NH (US)

(21) Appl. No.: 18/792,877

(22) Filed: Aug. 2, 2024

Related U.S. Application Data
(60) Provisional application No. 63/530,354, filed on Aug. 2, 2023.

(51) Int. Cl. C08J 3/075; B33Y 70/00; B33Y 80/00; C08L 5/16; C08L 71/02; G01L 1/14

(52) U.S. Cl. CPC C08J 3/075; B33Y 70/00; B33Y 80/00; C08L 5/16; C08L 71/02; G01L 1/142; C08J 2405/16; C08J 2471/02

(57) ABSTRACT

Embodiments of the present disclosure pertain to a rotaxane composition that includes macrocyclic rings and polymers, where the polymers are covalently appended to one or more macrocycle-binding molecules, where each of the macrocyclic rings includes a cavity that is threaded onto the polymers, where some of the threaded macrocyclic rings are individually threaded onto two polymers to form double-threaded macrocyclic rings with a plurality of different segments, where each of the plurality of different segments includes a plurality of double-threaded macrocyclic rings, and where the plurality of different segments associate with one another to form a crystalline network. Additional embodiments of the present disclosure pertain to sensors that include such compositions, methods of manufacturing a three-dimensional structure by applying such compositions onto a surface, and methods of forming such compositions.

### CROSS-REFERENCE TO RELATED APPLICATIONS

This application claims priority to U.S. Provisional Patent Application No. 63/530,354, filed on Aug. 2, 2024. The entirety of the aforementioned application is incorporated herein by reference.

### STATEMENT REGARDING FEDERALLY SPONSORED RESEARCH

This invention was made with government support under DE-SC0022267 awarded by the U.S. Department of Energy. The government has certain rights in the invention.

### BACKGROUND

A need exists for the development of more mechanically robust hydrogels. Numerous embodiments of the present disclosure aim to address the aforementioned need.

### SUMMARY

In some embodiments, the present disclosure pertains to a rotaxane composition that includes a plurality of macrocyclic rings and a plurality of polymers. The polymers are covalently appended to one or more macrocycle-binding molecules. Additionally, each of the plurality of macrocyclic rings includes a cavity that is threaded onto the polymers. Moreover, at least some of the threaded macrocyclic rings are individually threaded onto two polymers to form double-threaded macrocyclic rings. The double-threaded macrocyclic rings include a plurality of different segments. In some embodiments, each of the plurality of different segments includes a plurality of double-threaded macrocyclic rings. Additionally, the plurality of different segments associate with one another to form a crystalline network.

Additional embodiments of the present disclosure pertain to sensors that include a composition of the present disclosure. Further embodiments of the present disclosure pertain to methods of manufacturing a three-dimensional structure by applying a composition of the present disclosure onto a surface.

Embodiments of the present disclosure also pertain to methods of forming a rotaxane composition of the present disclosure. In some embodiments, the methods of the present disclosure include a step of covalently appending one or more macrocycle-binding molecules onto a plurality of polymers and threading a plurality of macrocyclic rings onto the plurality of polymers. The plurality of macrocyclic rings become threaded onto the polymers through their cavities. Additionally, at least some of the threaded macrocyclic rings become individually threaded onto two polymers to form double-threaded macrocyclic rings. The double-threaded macrocyclic rings form a plurality of different segments that each includes a plurality of double-threaded macrocyclic rings. Additionally, the plurality of different segments associate with one another to form a crystalline network.

### BRIEF DESCRIPTION OF THE DRAWINGS

FIG. 1 provides a depiction of a composition of the present disclosure.

FIGS. 2A-2C2 illustrate the development of crystalline-domain-reinforced 3D-printable double-threaded slide-ring hydrogels (CrysDoS-gels). FIG. 2A shows a traditional stretchable slide-ring gel. FIG. 2B shows a cartoon representation of a pro-slide-ring crosslinker with crystalline domains and dormant slide-ring joints. FIGS. 2C1-2C2 show CrysDoS-gels synthesized by copolymerizing the pro-slide-ring crosslinker and co-monomers. The CrysDoS hydrogel undergoes two-stage deformations by disrupting the crystalline domain followed by the γ-CD sliding.

FIGS. 3A-3E shows the synthesis and characterization of the pro-slide-ring crosslinker. FIG. 3A shows the job plots of MA-azo·Na and nap·Na with γ-CD in D₂O measured at 298 K. FIG. 3B shows the single-crystal structure of an azo-CO₂H·γ-CD 2:2 complex. FIG. 3C shows a ¹H NMR spectra (500 MHz, 298 K, D₂0) of i. 0.5 mM MA-azo·Na; ii. 0.5 mM MA-azo·Na and 0.5 mM γ-CD; iii. 0.5 mM PEG₄ₖ-azo; iv. 0.5 mM PEG₄ₖ-azo and 0.5 mM γ-CD; and v. 0.5 mM PEG₄ₖ-(azo)₂ and 1.0 mM γ-CD. FIGS. 3D-3E show the transmittance of the reaction of PEG₄ₖ-(nap)₂ and γ-CD.

FIGS. 4A-4E show the formation and characterization of pro-slide-ring crosslinker hydrogels. FIG. 4A shows images showing the rapid gelation upon mixing the aqueous solutions of PEG₄ₖ-(azo)₂ and γ-CD. FIG. 4B shows time-dependent rheological measurements by mixing solutions of PEG₄ₖ-(azo)₂, PEG₄ₖ-nap₂, and PEG₄ₖ-(OH)₂ and γ-CD, angular frequency: 10 rad/s. [PEG]=15 mM, [γ-CD]=120 mM. FIG. 4C shows step-strain profiles of polypseudorotaxane hydrogels composed of PEG₄ₖ-(azo)₂/γ-CD (top), PEG₄ₖ-(nap)₂/γ-CD (bottom). FIGS. 4D-4E show WAXS (FIG. 4D) and SAXS (FIG. 4E) profiles of polypseudorotaxanes composed of PEG₄ₖ-(azo)₂/γ-CD, PEG₄ₖ-(nap)₂/γ-CD, PEG₄ₖ-(OH)₂/γ-CD. A simulated WAXS of the HO-azo₂·γ-CD₂ single crystal was used as a reference.

FIGS. 5A-5E show the synthesis and characterizations of CrysDoS-gels. FIG. 5A shows the synthetic scheme of CrysDoS_{(15, 120)-HEMA}-gel using the pro-slide-ring crosslinker and HEMA. The Ctrl-gel was shown in FIG. 5E. FIG. 5B shows WAXS profiles of the CrysDoS_{(15, 120)-HEMA}-gel and a HO-azo·γ-CD 2:2 complex single-crystal (simulated from X-ray structure). FIG. 5C shows the swelling behaviors of CrysDoS-gels and Ctrl-gels with different amounts of MAANa co-monomer (10, 2, and 0 mol %, averaged value of 5 samples). Inset: images of these CrysDoS-gel and Ctrl-gels in their fully swelled and dried states (scale bar: 10.0 mm). P-values were calculated with a one-way analysis of variance (ANOVA) followed by post hoc Tukey multiple comparison tests. n. s. stands for not significant. FIGS. 5D-5E show tensile stress-strain (FIG. 5D) and cyclic loading profiles (FIG. 5E) of CrysDoS_{(15, 120)-HEMA}-gel and Ctrl-gel performed at room temperature (sizes: 30.0×8.0×2.0 mm, gauge length=3.0 mm, strain rate=1.5 mm/min).

FIGS. 6A-6D show high-throughput CrysDoS-gel synthesis and mechanical characterizations. FIG. 6A shows high-throughput synthesis of CrysDoS-gels in a 48-well plate and their various chemical inputs. FIG. 6B shows the measured toughness versus compressive moduli of the CrysDoS-gel library. FIGS. 6C-6D show compressive stress-strain and cyclic loading profiles of CrysDoS_{(8, 32)-DMA} (black), CrysDoS_{(8, 80)-DMA} (blue), and CrysDoS_{(17, 170)-DMA} (red), respectively.

FIGS. 7A-7F show implementation of data science for the prediction of materials properties and the discovery of CrysDoS-gels. FIGS. 7A-7B show machine-learning models using random forest regression, where a 70:30 train-test partition (using kernel density estimation) was employed for the prediction of (FIG. 7A) compressive moduli and (FIG. 7B) compressive toughness for 96 CrysDoS-gels. The solid black line is the y=x line, and the dashed black line is the line of best fit. FIG. 7C shows a bar plot depicting the importance of all five input features used to train the random forest models predicting hysteresis, compressive moduli, and compressive toughness of CrysDoS gels.

FIGS. 7D-7E show multivariate linear regression models for the prediction of (FIG. 7D) compressive moduli and (FIG. 7E) compressive toughness of CrysDoS-gels. These models were used to predict better-performing CrysDoS-gels. The solid black line is the y=x line, and the dashed black line is the line of best fit. FIG. 7F shows uniaxial compressive profiles of CrysDoS_{(30, 240)-AM} and CrysDoS_{(30, 300)-DMA}, strain rate: 1 mm/min. The measured log (E) in FIG. 7D is represented by 0.267 [PEG]*+0.207 [CD]/[PEG]*+2.07. The measured log (U) in FIG. 7E is represented by 0.162 [PEG]*+0.271 [CD]/[PEG]*+0.088 1nK_{poly}*+2.04.

FIGS. 8A-8E show 3D-printing of ionic CrysDoS-gels as stress sensors. FIG. 8A shows 3D-printed CrysDoS_{(15, 120)-HEA/AANa} lattices using the pro-slide-ring hydrogel inks. FIG. 8B shows 3D-printed heterogeneous capacitive stress sensor using CrysDoS_{(17, 136)-HEA/AANa} and CrysDoS_{(8, 48)-HEA/AANa} inks. FIG. 8C shows plots of relative capacitance changes of molded CrysDoS_{(8, 48)-HEA/AANa}, molded CrysDoS_{(17, 136)-HEA/AANa}, 3D-printed CrysDoS_{(17, 136)-HEA/AANa}, and 3D-printed hetero-sensor upon compressing. FIG. 8D shows comparison of the low-pressure stress sensitivity (0-10 kPa) of the molded CrysDoS_{(8, 48)-HEA/AANa}, molded CrysDoS_{(17, 136)-HEA/AANa}, 3D-printed CrysDoS_{(17, 136)-HEA/AANa}, and 3D-printed heterosensor samples. P-values were calculated with a one-way ANOVA followed by post hoc Tukey multiple comparison tests of three samples. FIG. 8E shows a performance plot to compare the sensitivity and the range of detection of this work with state-of-the-art hydrogel-based capacitive stress sensors.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Synthetic polymer-based hydrogels have been extensively exploited for biomedical, pharmaceutical, and mechanical engineering due to their biocompatibility, high-water content, and tunable chemical and physical properties. Currently, various hydrogels with different mechanical properties have been synthesized through molecular designs tailored to meet the requirements of the deploying environment. For example, hydrogels designed for contact lenses must be soft and less swellable, which were synthesized as covalently crosslinked polymer networks. Calcium alginate dressings used for wound healing are formed by physically crosslinking alginate with calcium ions, and are designed to swell to speed wound homeostasis.

However, the rapidly expanding demands for hydrogels greatly exceed the chemical and physical properties that conventional hydrogels can offer. Hence, extensive fundamental efforts have been made to design and synthesize polymers with advanced network architectures. One example of such an architecture is the double network (or interpenetrated network), in which one dissipative polymer network is infused into another dissimilar polymer network. As a result of the double network design, strong and stretchable hydrogels have been developed

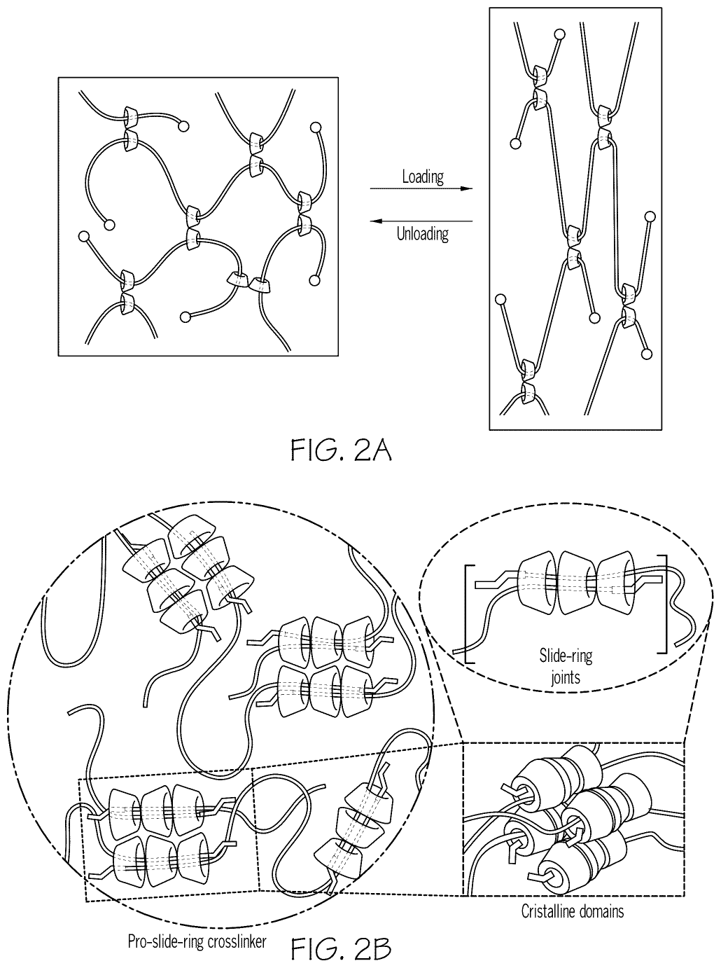

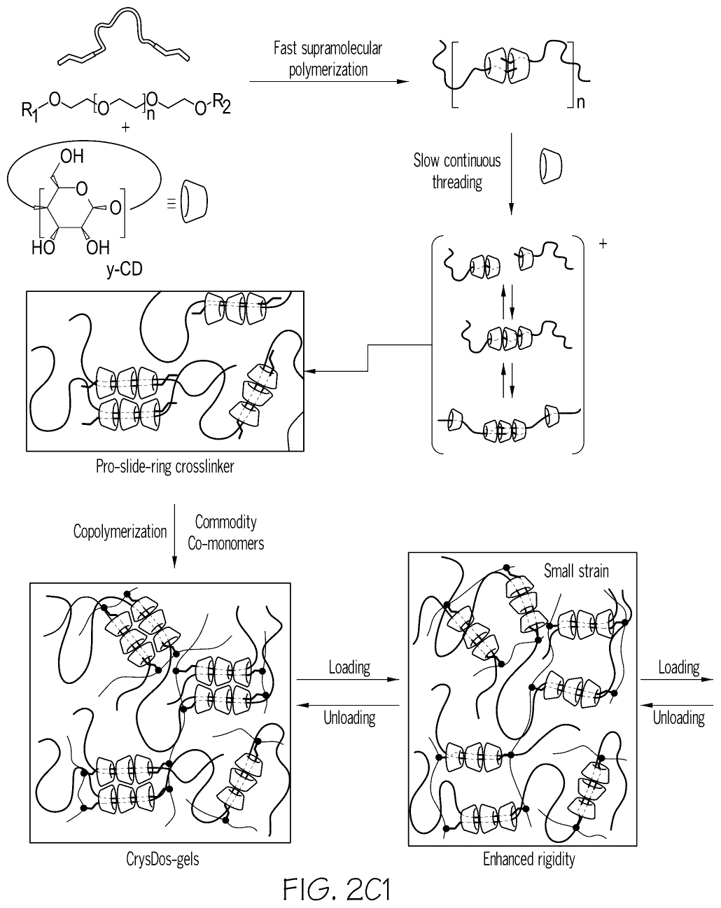

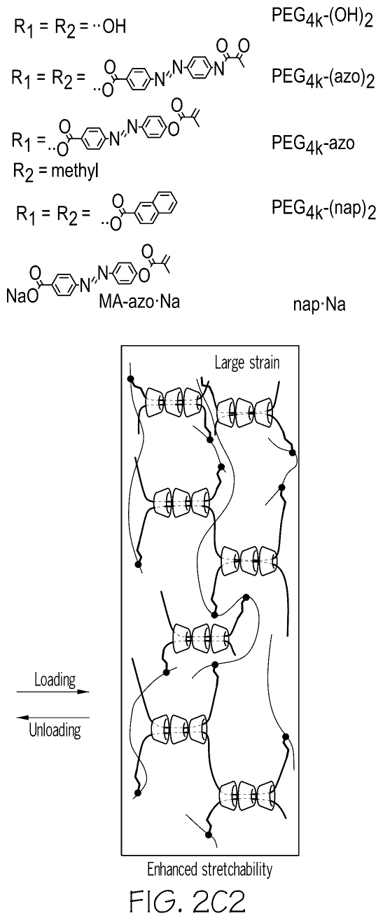

Another breakthrough is the development of slide-ring gels with mobile crosslinkers (FIG. 2A). In these slide-ring gels, polymers were connected by a pair of covalently linked α-cyclodextrins (α-CDs) sliding along the polymer chain. Slide-ring gels feature a mechano-adaptive network in which the mobile crosslinkers reorganize themselves in response to the external mechanical force.

Slide-ring gels with mobile crosslinkers exhibit exceptional stretchability and high toughness, making them attractive for applications requiring high stretchability, toughness, and recoverability. For instance, when slide-ring networks are integrated with batteries, elastomers, and 3D-printed hydrogels, the mechanical properties of the materials have been significantly improved. However, they tend to be soft because the activation energy required for ring pairs sliding is low, resulting in an elasticity-toughness trade-off in the current slide-ring gel design.

Therefore, it is of utmost importance to explore new chemical approaches that can break the trade-off between low elasticity and high toughness in slide-ring gels. Such advances would expand their potential applications to materials such as scratch-proof coatings and robust electronic skins.

The challenge is to reinforce the slide-ring networks while still preserving the mobility of the dynamic crosslinkers. Moreover, it is imperative to create modular pro-slide-ring crosslinkers that can be easily converted into slide-ring networks in one step through copolymerization with commodity monomers, akin to how prochiral compounds can be transformed into chiral products through a single step. With a facile and modular synthesis, the discovery of slide-ring crosslinked materials of diverse mechanical properties could be greatly accelerated.

As such, a need exists for the development of more mechanically robust slide-ring networks. Numerous embodiments of the present disclosure aim to address the aforementioned need.

### Compositions

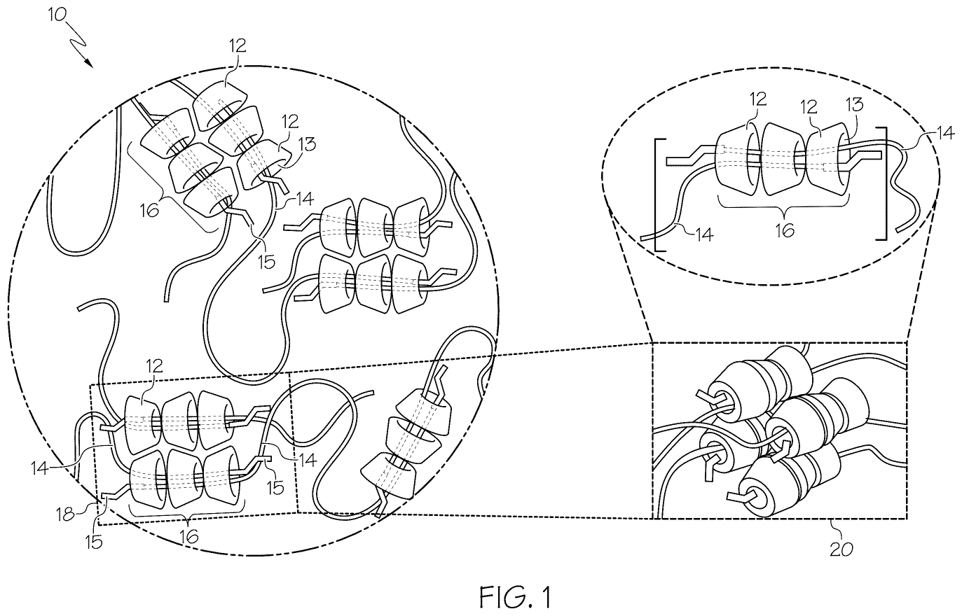

In some embodiments, the present disclosure pertains to a rotaxane composition. An example of a rotaxane composition is illustrated in FIG. 1 as composition 10, which includes a plurality of macrocyclic rings 12 and a plurality of polymers 14. Polymers 14 are covalently appended to one or more macrocycle-binding molecules 15. Additionally, each of the plurality of macrocyclic rings 12 includes a cavity 13 that is threaded onto the polymers 14.

Moreover, at least some of the threaded macrocyclic rings 12 are individually threaded onto two polymers 14 to form double-threaded macrocyclic rings. The double-threaded macrocyclic rings include a plurality of different segments 16. In some embodiments, each of the plurality of different segments 16 includes a plurality of double-threaded macrocyclic rings. Additionally, the plurality of different segments 16 associate with one another to form a crystalline network 20. In some embodiments, the crystalline network is in the form of a crystalline domain with connected networks.

As set forth in more detail herein, the compositions of the present disclosure can have numerous embodiments.

### Macrocyclic Rings

The compositions of the present disclosure can include various types of macrocyclic rings. For instance, in some embodiments, the macrocyclic rings include cyclic oligosaccharides. In some embodiments, the macrocyclic rings include, without limitation, cyclodextrins, cyclodextrin derivatives, or combinations thereof.

In some embodiments, the macrocyclic rings include cyclodextrins. In some embodiments, the cyclodextrins include, without limitation, β-cyclodextrin (β-CD), γ-cyclodextrin (γ-CD), r-cyclodextrin (r-CD), derivatives thereof or combinations thereof. In some embodiments, the macrocyclic rings include γ-cyclodextrin (γ-CD). In some embodiments, the macrocyclic rings include r-cyclodextrin (r-CD). In some embodiments, the macrocyclic rings include derivatives of r-CD. In some embodiments, the r-CD derivatives include, without limitation, permethyl-r-CD, tosyl-r-CD, 2-Hydroxypropyl-rCD (e.g., where all OH groups are replaced by 2-Hydroxypropyl), Thiol-rCD, acylate-rCD, or combinations thereof.

### Polymers

The compositions of the present disclosure can also include various types of polymers. For instance, in some embodiments, the polymers include, without limitation, nonionic amphiphilic polymers, polyethylene glycol (PEG), polyethylene oxide (PEO), telechelic polyethylene glycol, poly(propylene oxide), polyalkyl ethers, block copolymers thereof, or combinations thereof. In some embodiments, the polymers include polyethylene glycol (PEG). In some embodiments, the polymers include block copolymers of polyethylene glycol (PEG) and polyethylene oxide (PEO). In some embodiments, the polymers are in the form of a network.

### Segments

The compositions of the present disclosure can also include various types of segments. For instance, in some embodiments, each segment includes at least 3 macrocyclic rings. In some embodiments, each segment includes at least 6 macrocyclic rings. In some embodiments, the segments are associated with one another in a parallel direction.

### Macrocycle-Binding Molecules

The compositions of the present disclosure can also include various types of macrocycle-binding molecules. For instance, in some embodiments, the macrocycle-binding molecules include, without limitation, cycloalkanes, cyclohexanes, camphors, adamantanes, norbornanes, bornanes, azobenzene (azo), 4′-hydroxy azobenzene-4-carboxylic acid, stilbene, biphenyl, terphenyl, naphthalene (nap), derivatives thereof, or combinations thereof. In some embodiments, the macrocycle-binding molecules include azobenzene (azo) or derivatives thereof. In some embodiments, the macrocycle-binding molecules include naphthalene (nap) or derivatives thereof.

In some embodiments, the polymers are appended to a single macrocycle-binding molecule. In some embodiments, the polymers are appended to a plurality of macrocycle-binding molecules. In some embodiments, the plurality of macrocycle-binding molecules are appended to the polymers such that the plurality of macrocyclic rings are between the plurality of macrocycle-binding molecules. In some embodiments, each end of the polymers are covalently appended to a macrocycle-binding molecule.

### Composition Forms

The compositions of the present disclosure may be in various forms. For instance, in some embodiments, the compositions of the present disclosure are in the form of hydrogels. In some embodiments, the compositions of the present disclosure are in 3-D printable form.

### Sensors

Additional embodiments of the present disclosure pertain to a sensor that includes a composition of the present disclosure. In some embodiments, the sensor includes a stress sensor. In some embodiments, the stress sensor includes a capacitive stress sensor and a resistive stress sensor.

### Methods of Printing

Additional embodiments of the present disclosure pertain to methods of manufacturing a three-dimensional structure by applying a composition of the present disclosure onto a surface. In some embodiments, the applying results in the formation of the three-dimensional structure on the surface. In some embodiments, the applying occurs by additive manufacturing.

In some embodiments, the printing methods of the present disclosure also include a step of covalently cross-linking the three-dimensional structure. In some embodiments, the covalent cross-linking occurs by photo-irradiation. In some embodiments, cross-linking occurs through the utilization of a cross-linker, such as a ketoenamine-based cross-linker. In some embodiments, the ketamine-based cross-linker includes, without limitation, 1,3,5-benzenetrialdehyde (BD), 1,3,5-triformylphloroglucinol (TP), or combinations thereof. The use of ketoenamine-based cross-linkers is disclosed in Polym. Chem., 2023,14, 2159-2163 and incorporated herein by reference.

### Methods of Making Compositions

Additional embodiments of the present disclosure pertain to methods of forming a rotaxane composition. In some embodiments, the methods of the present disclosure include a step of covalently appending one or more macrocycle-binding molecules onto a plurality of polymers and threading a plurality of macrocyclic rings onto the plurality of polymers. The plurality of macrocyclic rings become threaded onto the polymers through their cavities. Additionally, at least some of the threaded macrocyclic rings become individually threaded onto two polymers to form double-threaded macrocyclic rings. The double-threaded macrocyclic rings form a plurality of different segments that each includes a plurality of double-threaded macrocyclic rings.

Additionally, the plurality of different segments associate with one another to form a crystalline network. In some embodiments, the crystalline network determines the macroscopic properties of the materials, including viscoelasticity, elastic moduli, mechanical strength, and mechanical recoverability.

In some embodiments, the polymers become appended to a single macrocycle-binding molecule. In some embodiments, the polymers become appended to a plurality of macrocycle-binding molecules. In some embodiments, the plurality of macrocycle-binding molecules become appended to the polymers such that the plurality of macrocyclic rings are between the plurality of macrocycle-binding molecules. In some embodiments, each end of the polymers become covalently appended to a macrocycle-binding molecule. An example of a method of forming rotaxane composition is illustrated in FIGS. 2A-2C2 and described in more detail in Example 1.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Construction of Crystalline Domain-Reinforced Slide-Ring Hydrogels (CrysDos-Gels)

Stretchable slide-ring hydrogels are typically soft due to the elasticity-toughness trade-off. In this Example, Applicant developed a crystalline-domain reinforced double-threaded slide-ring networks by introducing a pro-slide-ring crosslinker synthesized through the self-assembly of γ-cyclodextrins and telechelic polyethylene glycols. Applicant obtained 3D-printable rigid and tough slide-ring hydrogels. The modular reactivity of the pro-slide-ring crosslinker enabled a high-throughput synthesis, resulting in a library of slide-ring hydrogels with varying mechanical properties. Applicant illustrates the structure-property relationships of these hydrogels using data science tools, which led to the discovery of superior hydrogels. Applicant fabricated a high-performance 3D-printed stress sensor, showing the potential of this design. Introducing a modular pro-slide-ring crosslinker with a clearly illustrated structure-property relationship greatly accelerates the discovery of mechanically robust slide-ring-based soft materials.

In particular, Applicant introduces in this Example a new approach to create reinforced slide-ring networks with mobile crosslinkers. Applicant's approach involves the construction of a polyethylene glycol double-threaded γ-cyclodextrin-based pro-slide-ring crosslinker, which serves as a modular component for 3D-printing and copolymerization. The resulting crystalline-domain reinforced slide-ring hydrogels, or CrysDoS-gels, exhibit both high elasticity and high stretchability. The modular synthesis allows for high-throughput synthesis of CrysDoS-gels, generating a large amount of data for structure-property analysis. By employing data science techniques such as machine learning and linear regression, Applicant was not only able to identify which chemical components influence mechanical properties in CrysDoS-gels, but this analysis also aided the discovery of better-performing CrysDoS-gels. Finally, Applicant demonstrates the potential application of the newly discovered CrysDoS-gels as sensing devices by 3D-printing them as stress sensors with high sensitivity and broad detection range.

In response to the challenges of discovering mechanically robust slide-ring networks, Applicant introduces a new approach that utilizes modular crystalline-domain-reinforced pro-slide-ring crosslinkers to accelerate the process. These modular crosslinkers are suitable for direct-ink-writing 3D-printing and enable high-throughput synthesis due to their rapid gelation and excellent viscoelasticity. A typical pro-slide-ring crosslinker is a supramolecular polymer formed by double-threaded polyethylene glycols (PEGs) in γ-CDs (FIG. 2B), which can react with various co-monomers for slide-ring network formation (FIGS. 2C1-2C2). The modular reactivity and optimal viscoelasticity of pro-slide-ring crosslinkers enable high-throughput synthesis and 3D-printing. As such, a sizable library of hydrogel materials with various elastic moduli, compressibility, and viscoelasticity were obtained through high-throughput synthesis.

Among them, Applicant has identified a group of hydrogels which exhibit high elasticity and toughness, breaking the elasticity-toughness trade-off in conventional slide-ring networks and facilitating additional 3D printability. This library of CrysDoS-gels also enabled Applicant to leverage machine learning methods and multivariate linear regression techniques to identify structure-property relationships and discover better materials. These hydrogels were then fabricated as capacitive stress sensors through multi-material 3D-printing, exhibiting both high sensitivity and a broad range of detection.

Slide-ring gels with mobile crosslinkers are typically synthesized in solution by either crosslinking two α-CDs on different polyrotaxanes (FIG. 2A) or copolymerizing acrylate monomers with vinyl-α-CD-threaded polyrotaxanes. To achieve stretchable slide-ring gels, the hydroxyls of α-CDs are substituted to prevent inter-α-CD hydrogen-bonding. Otherwise, α-CD aggregations can hinder their free sliding along the axle to limit the mobility of the crosslinker. These factors render these slide-ring gels stretchable but soft. Alternatively, γ-CD is known to accommodate two PEG axles in its cavity to form doubly threaded assemblies. The dual threading of PEG axles inside γ-CD could be promoted by installing aromatic end groups to PEG for ternary complex formation. When γ-CDs are used for the construction of networks with double-threaded mobile junctions, the yielded slide-ring gels remain soft. Moreover, to maximize the translocation distances for mobile crosslinkers, fewer modified α-CDs or γ-CD per axle are desirable, but controlling the number of threaded CDs through synthetic modulation remains a challenge.

To overcome these challenges, Applicant opted for γ-CD as the mobile ring crosslinker to construct stretchable and rigid slide-ring networks, capitalizing on the kinetically formed crystalline γ-CD aggregates. Two PEG axles PEG₄ₖ-(azo)₂ and PEG₄ₖ-(nap)₂ (Mₙ of 4 kDa) are designed as axles with their end groups known to form 2:1 or 2:2 complexes with γ-CD (FIGS. 2C1-2C2). When 7-CDs are mixed with PEG₄ₖ-(azo)₂, 7-CD-connected supramolecular polymers form rapidly. The high affinity (azo)₂·γ-CD inclusion complexes formed at the joints of the supramolecular polymer not only limit the continuous γ-CD-threading but also trigger a kinetically accelerated crystallization process at room temperature, affording the pro-slide-ring crosslinker (FIG. 2C1-2C2).

Three PEG axles, including PEG₄ₖ-(azo)₂, PEG₄ₖ-azo/Me, and PEG₄ₖ-(nap)₂ were synthesized by end-group esterification (FIGS. 2C1-2C2). The corresponding model compounds of these end groups, which include MA-azo·Na, 4′-hydroxy azobenzene-4-carboxylic acid (azo-CO₂H), and nap·Na, were also prepared for the investigation.

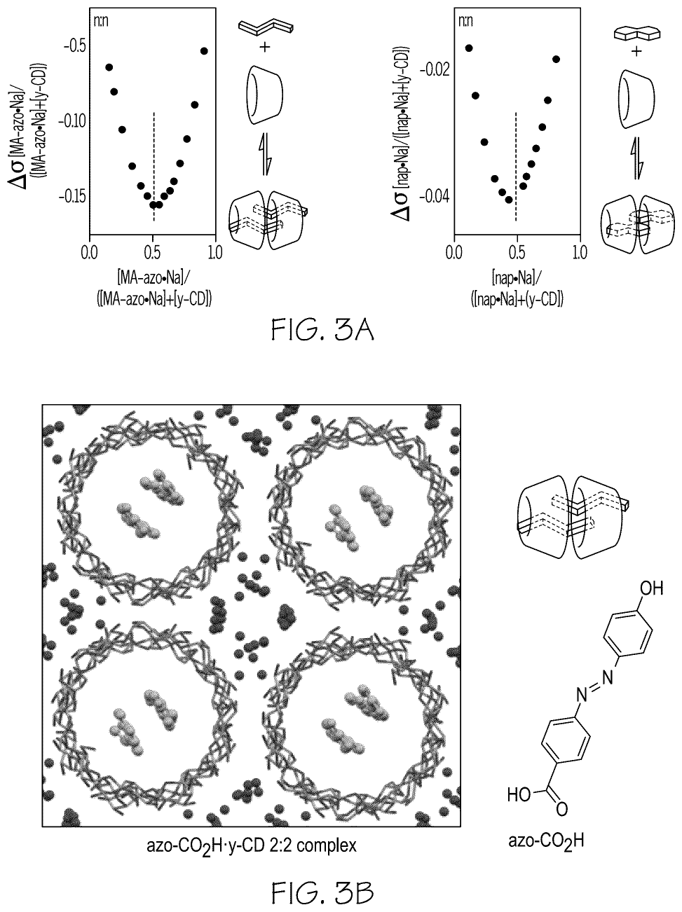

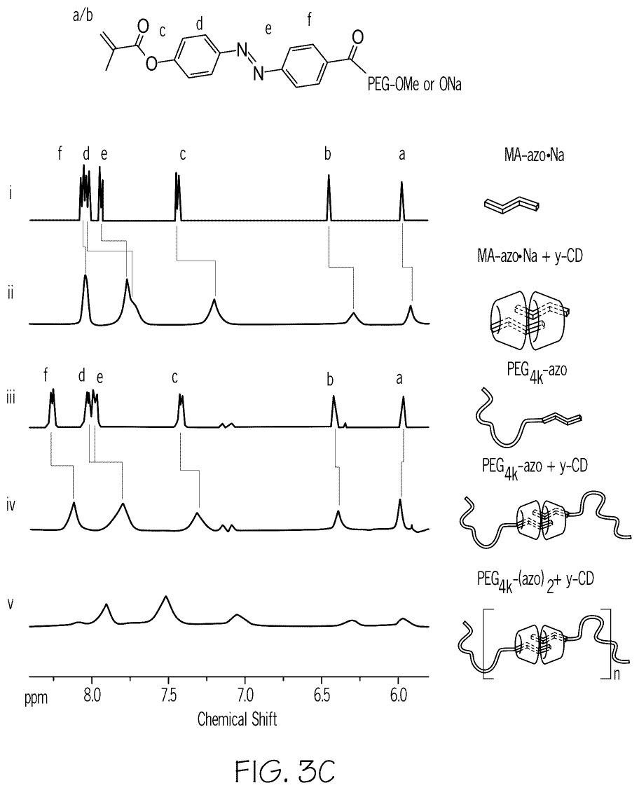

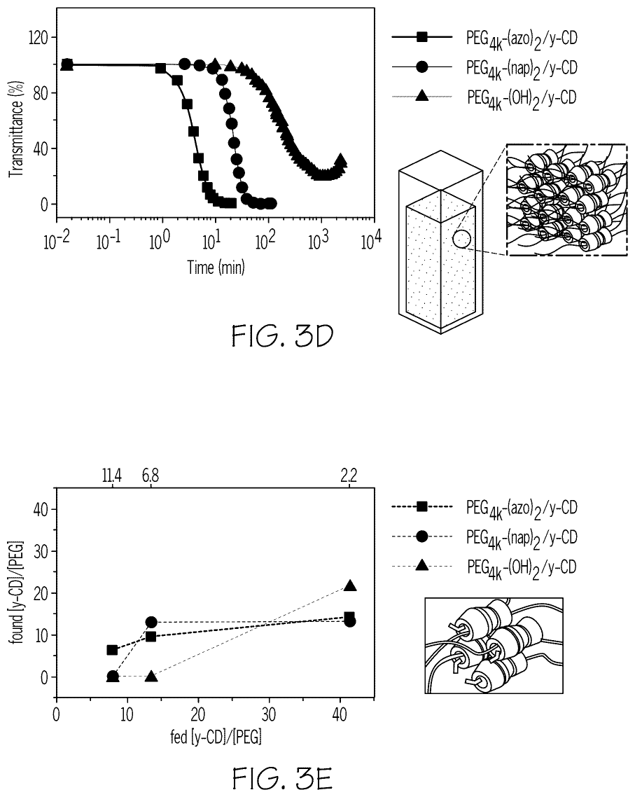

Job plots (FIG. 3A) suggested that both MA-azo·Na and nap·Na form n:n inclusion complexes with γ-CDs. The binding stoichiometries of these inclusion complexes were confirmed as 2:2 complexes (MA-azo)₂·(γ-CD)₂ and (nap)₂·(γ-CD)₂ through NMR experiments, and the aid of the single-crystal X-ray structure analysis of the (azo-CO₂H)₂·(γ-CD)₂ complex (FIG. 3B). The binding affinities between a pair of MA-azo·Na and γ-CD were measured as K₁=(1.8±0.2)×10⁴ M⁻¹ and K₂=(1.7±0.1)×10³ M⁻¹ using ¹H NMR titration at 298 K. Similarly, the binding affinities between a pair of nap·Na and γ-CD were measured as K₁=180±1 M⁻¹ and K₂=5.0±0.1 M⁻¹.

Compared to MA-azo·Na, the proton resonances of the MA-azo·γ-CD 2:2 complex shifted upfield due to the shielding of the neighboring co-included MA-azo (FIG. 3C, i to ii). Similar shifts were also observed in a 1:1 mixture of PEG₄ₖ-azo/Me and γ-CD in D₂O and a 1:1 mixture of PEG₄ₖ-(azo)₂ and γ-CD in D₂O (FIG. 3C, iv and v), confirming formation of 2:2 complexes between γ-CDs and the end groups of these PEG axles. 1D and 2D NOE experiments revealed that these azobenzene end groups were co-threaded from opposite directions, generating linear supramolecular polymers in the solution. The ¹H NMR studies of the 1:1 mixture of PEG₄ₖ-(nap)₂ and γ-CD showed similar phenomena.

In the presence of an excess of γ-CD, PEG axles are known to form double PEG-threaded polypseudorotaxanes and crystallize as polypseudorotaxane precipitates. The kinetic process could be monitored via time-dependent turbidity experiments. For example, the transmittance of a γ-CD/PEG₄ₖ-(OH)₂ mixture ([γ-CD]=51.3 mM, [PEG₄ₖ-(OH)_{2]=1.25} mM, FIG. 3D) reached ≤20% in 920 min at 20° C. ¹H NMR analysis showed that an average of 21.7 γ-CDs were threaded on the PEG₄ₖ-(OH)₂ in the crystalline precipitates (FIG. 3E). In comparison, the transmittance of the reaction of PEG₄ₖ-(nap)₂ and γ-CD reached ≤1% only after 48 min, and 13.2 γ-CDs were threaded on PEG₄ₖ-(nap)₂ in the polypseudorotaxanes (FIGS. 3D-3E).

When PEG₄ₖ-(azo)₂ was used as the axle, the polypseudorotaxane formation and crystallization rates were further accelerated. The transmittance of the reaction of γ-CD (51.3 mM) and PEG₄ₖ-(azo)₂ (1.25 mM) started to decrease after just 1 min and reached ≤1% in 17 min (FIG. 3D). ¹H NMR analysis revealed that an average of 13.9 γ-CDs were threaded onto each PEG₄ₖ-(azo)₂ axle (FIG. 3E). Furthermore, unlike sizable crystals of PEG₄ₖ-(OH)₂/γ-CD polypseudorotaxanes observed under optical microscopy, micro-crystalline precipitates were formed by PEG₄ₖ-(azo)₂ or PEG₄ₖ-(nap)₂ and γ-CD. These results suggested that high-affinity binding end groups of the PEG axle, such as the methacrylate azobenzene moieties, rapidly recruit γ-CDs in the solution, forming stable 2:2 complexes. These stable complexes slow down the continuous γ-CD threading, resulting in an early crystallization of polypseudorotaxanes with fewer threaded γ-CDs per PEG axle (FIGS. 2C1-2C2).

The kinetically accelerated polypseudorotaxane formation and crystallization enabled Applicant to trap fewer γ-CDs per PEG axle. When the feeding ratios of γ-CD to PEG were decreased from 41.4:1 to 13.4:1 and 8.0:1, no precipitation was observed during the reactions of γ-CD/PEG₄ₖ-(OH)₂ (FIG. 3E). At a feed ratio of γ-CD: PEG₄ₖ-(nap)₂=13.4:1, no transmittance changes were observed until 400 min for the PEG₄ₖ-(nap)₂/γ-CD polypseudorotaxane, reaching ≤80% after ˜1,300 min with a found γ-CD: PEG ratio of 11.5. When the feeding γ-CD: PEG₄ₖ-(nap)₂ ratio was decreased to 8.0:1, no precipitation was observed. In contrast, PEG₄ₖ-(azo)₂/γ-CD polypseudorotaxanes rapidly formed and precipitated at these feeding ratios, and the time required to reach 1% transmittance are 17, 29, and 88 min. The kinetically trapped γ-CDs per PEG₄ₖ-(azo)₂ were measured as 13.9, 7.2, and 5.8, respectively (FIG. 3E). These results suggested that the end groups of PEG₄ₖ-(azo)₂ effectively stabilized the threaded γ-CDs to trigger early crystallization. This method offers a unique way to synthesize polypseudorotaxanes with fewer threaded γ-CDs, enabling the construction of slide-ring gels with larger ring sliding distances.

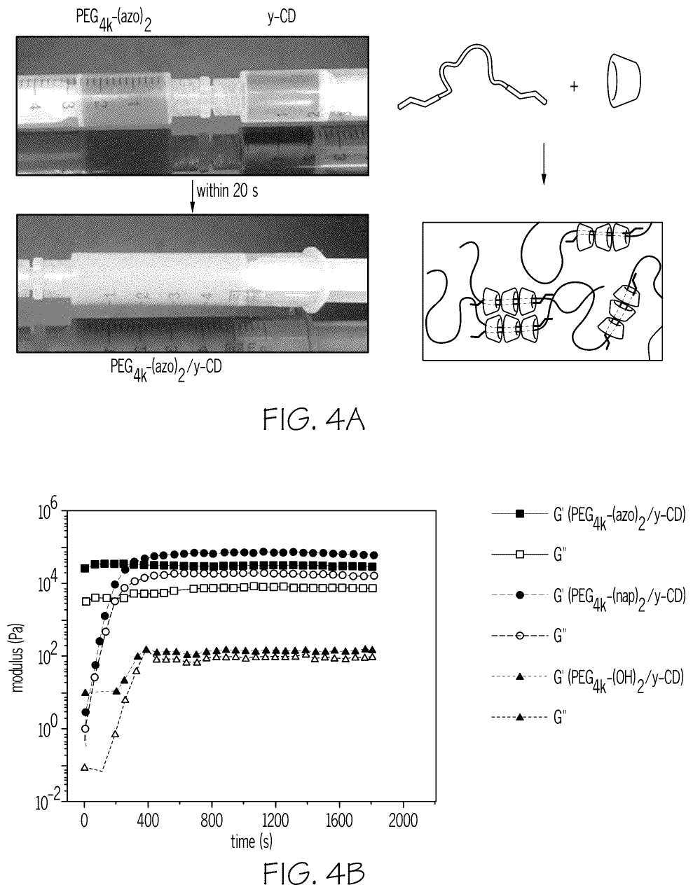

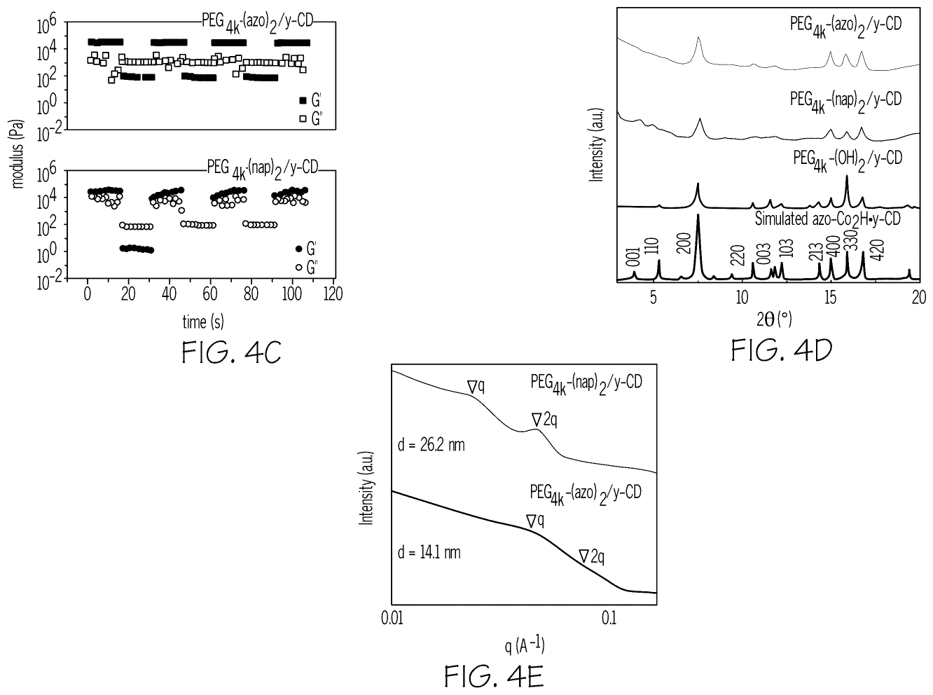

Interestingly, viscoelastic polypseudorotaxanes hydrogels were formed rapidly upon mixing γ-CD and PEG₄ₖ-(azo)₂ at a higher concentration. As shown in FIG. 4A, two syringes loaded with a γ-CD solution (120 mM) and a PEG₄ₖ-(azo)₂ solution (15 mM) were connected via a Luer lock connector. Within just 20 seconds of back-and-forth mixing, an opaque viscoelastic hydrogel was formed at room temperature. Time-dependent angular frequency measurements showed that a stable hydrogel with elastic moduli G′≈30 kPa had already formed when the mixture was loaded onto the rheometer (FIG. 4B). In comparison, the rate of gelation for PEG₄ₖ-(nap)₂/γ-CD polypseudorotaxane reached a steady state after 5 min with G′≈70 kPa (FIG. 4B). When PEG₄ₖ-(OH)₂ (15 mM) was mixed with γ-CD (120 mM), white suspensions were formed after 5 min, exhibiting elastic moduli of ˜150 Pa and loss moduli G″ of ˜100 Pa. Both PEG₄ₖ-(azo)₂/γ-CD and PEG₄ₖ-(nap)₂/γ-CD polypseudorotaxanes hydrogels showed full recovery in the step-strain rheological sweeps (FIG. 4C), while PEG₄ₖ-(OH)₂/γ-CD polypseudorotaxane suspension exhibited as a Newtonian liquid upon shearing. The optimal viscoelastic properties of PEG₄ₖ-(azo)₂/γ-CD and PEG₄ₖ-(nap)₂/γ-CD hydrogels are attributed to the formation of micro-crystalline domains in these hydrogels similar to those of 3D-printable α-CD-based polypseudorotaxane hydrogels.

To probe the super-structures in these hydrogels, wide- and small-angle X-ray scattering diffractions (WAXS and SAXS) profiles of the samples were collected, and the simulated diffraction profile of the (azo-CO₂H)₂·(γ-CD)₂ single crystal was used as a reference. The WAXS profiles of PEG₄ₖ-(OH)₂/γ-CD, PEG₄ₖ-(nap)₂/γ-CD, and PEG₄ₖ-(azo)₂/γ-CD polypseudorotaxane samples matched diffraction profiles to that of (azo-CO₂H)₂·(γ-CD)₂ (FIG. 4E), confirming the presence of γ-CD-based crystalline domains. The WAXS profile of PEG₄ₖ-(OH)₂/γ-CD is significantly sharper than those of PEG₄ₖ-(nap)₂/γ-CD, and PEG₄ₖ-(azo)₂/γ-CD polypseudorotaxanes, suggesting that the sizes of the crystalline domains in these hydrogels are smaller according to the Scherrer equation. In SAXS analysis, the PEG₄ₖ-(azo)₂/γ-CD hydrogel showed diffractions fitted to lamellar structures with d spacing distances of 14.1 nm, indicating the crystalline domains consist around 18.5 γ-CDs. A larger d=26.2 nm was fitted to the PEG₄ₖ-(nap)₂/γ-CD hydrogel, corresponding to crystalline domains of 34.4 γ-CDs. These results suggest that smaller and less-defined crystalline domains were formed in the PEG₄ₖ-(azo)₂/γ-CD hydrogel compared to those that are larger and ordered in the PEG₄ₖ-(nap)₂/γ-CD hydrogel.

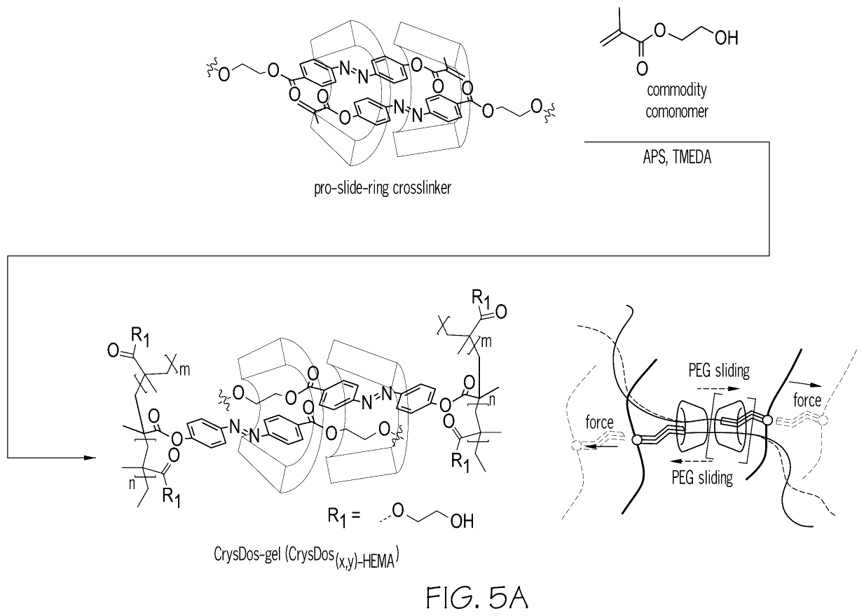

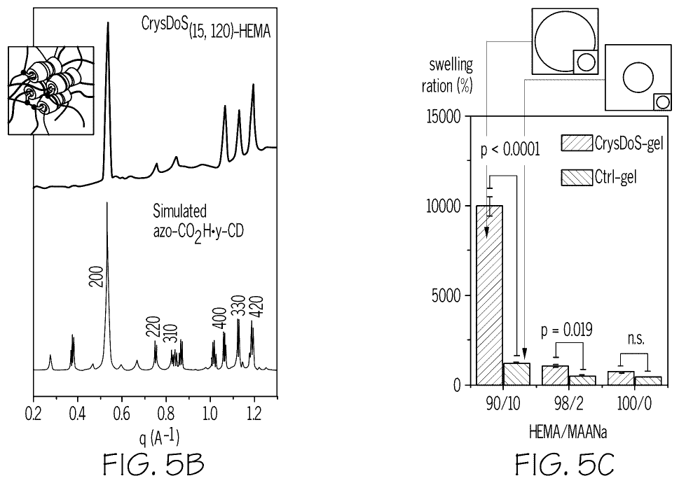

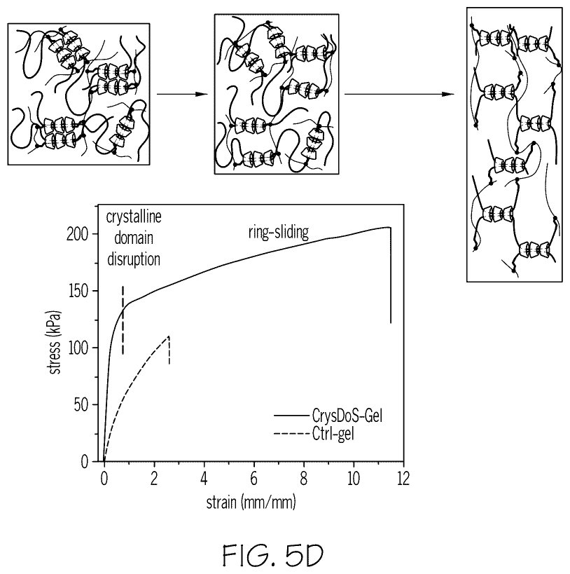

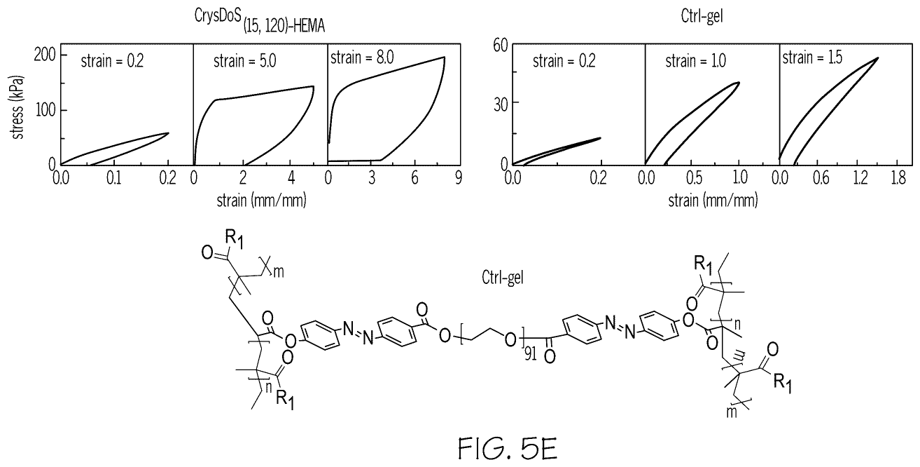

When the methacrylate groups of PEG₄ₖ-(azo)₂/γ-CD polypseudorotaxanes are co-polymerized with commodity monomers, the pro-slide-ring crosslinkers are converted to crystalline-domain reinforced slide-ring (CrysDoS)-gels (FIG. 5A). These CrysDoS-gels possess unique network features, including crystalline domain cross-linkages and dormant slide-ring joints that can be activated upon the disruption of the crystalline domains.

To synthesize a CrysDoS hydrogel, a pro-slide-ring crosslinker is utilized, consisting of PEG and γ-CD, along with a co-monomer, and initiators tetramethylethylenediamine (TMEDA) and ammonium persulfate (APS). As a result, these hydrogels are designated as CrysDoS_{(a, b)-X}, where a and b represent the millimolar concentrations of PEG and γ-CD, respectively, while X denotes the specific type of co-monomer employed.

A CrysDoS_{(15, 120)-HEMA}-gel was synthesized by first combining the pro-slide-ring crosslinker with hydroxyl ethylene methacrylate (HEMA, FIG. 5A) to form a precursor hydrogel, which then underwent covalent crosslinking. The elastic modulus G′(22 kPa) of the precursor hydrogel is slightly smaller than that of the pro-slide-ring hydrogel (36 kPa) because the large excess of the HEMA co-monomer competes with the PEG axle for γ-CD binding. Post-crosslinking, the conversion of the methacrylate groups for PEG₄ₖ-(azo)₂ was determined to be >90% through ¹H NMR swelling and digestion experiments. For comparative purposes, a control hydrogel in the absence of γ-CD (Ctrl-gel, FIGS. 5D-5E) was also synthesized. The CrysDoS_{(15, 120)-HEMA}-gel and the Ctrl-gel were washed extensively to remove unreacted species and immersed in Na₂SO₄ aqueous solutions to reach the same water content of 46 wt %. WAXS analysis (FIG. 5B) showed that the γ-CD crystalline domains were well preserved in the CrysDoS_{(15, 120)-HEMA}-gel. SAXS analysis showed a lamellar structure with a d-spacing distance of 14.0 nm, similar to that of the pro-slide-ring gel, indicating that the addition of co-monomers had minimal impact on the crystalline domains in the synthesized CrysDoS-gel.

When the crystalline domains of the CrysDoS_{(15, 120)-HEMA}-gel are disrupted, the hydrogel should undergo significant swelling due to the sliding motions of γ-CDs, similar to traditional slide-ring gels. However, the swelling ratio of the CrysDoS_{(15, 120)-HEMA}-gel was measured as 690±20% (FIG. 5C) that is comparable to the Ctrl-gel, indicating that the crystalline domains of the CrysDoS-gel remained largely intact. Adding small amounts of the ionic co-monomer sodium methacrylate (MAANa) gradually increased the osmotic pressure for swelling, disrupting the crystalline domains in the CrysDoS-gel. At an MAANa/HEMA ratio of 1:9, the CrysDoS_{(15, 120)-HEMA/MAANa}-gel demonstrated a significantly higher swelling ratio of 10,000±500%, which is nearly 10 times larger than that of the Ctrl_{HEMA/MAANa}-gel (FIG. 5C), attributing to the activated mobile γ-CD joints.

The CrysDoS_{(15, 120)-HEMA}-gel exhibits high Young's modulus (E=520±20 kPa) and high stretchability (11.4±1.3 mm/mm) in the uniaxial tensile tests (FIG. 5D), compared to 100±10 kPa and 2.6±0.4 mm/mm for the Ctrl-gel, respectively. Considering that traditional slide-ring gels usually have similar Young's moduli to their fixed crosslinked counterparts, the five-fold higher Young's modulus enhancement here highlights the benefits of the γ-CD crystalline domain reinforcements. Notably, the tensile profile of the CrysDoS_{(15, 120)-HEMA}-gel exhibited a two-stage characteristic. At low strains (≤0.5 mm/mm), the CryDoS-gel underwent an elastic deformation with the tensile stress reaching ˜130 kPa due to the crystalline domain disruption. At higher strains, the released mobile γ-CDs slide upon stretching, and the tensile stress gradually increases to ˜200 kPa (FIG. 5D), similar to traditional slide-ring gels. The high Young's modulus and high stretchability of the CrysDoS_{(15, 120)-HEMA}-gel resulted in a high toughness of 2.1±0.3 MJ/m³, which is ten-fold higher than the Ctrl-gel (0.19±0.05 MJ/m³). In the cyclic loading-unloading tensile measurements (FIG. 5E), the CrysDoS_{(15, 120)-HEMA}-gel showed large hysteresis (1−U₂U₁) of 0.77 and 0.74 at strains of 5.0 and 8.0 mm/mm, respectively, which are larger than those of the Ctrl-gel (FIG. 5E). These results highlight the benefits of the design of CrysDoS-gels for enhanced mechanical performance.

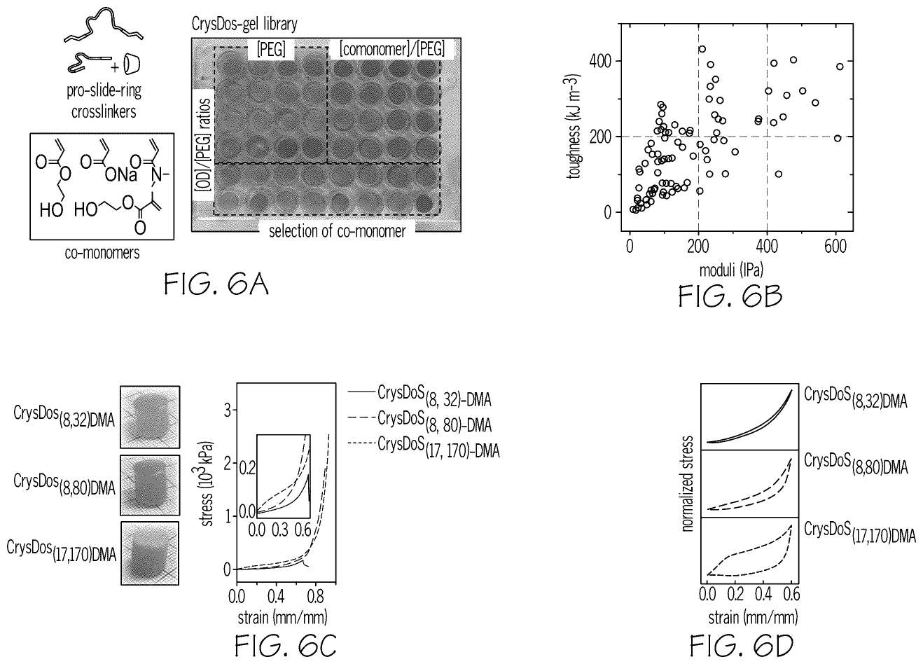

The rapid gelation of the pro-slide-ring crosslinkers and modular synthesis of CrysDoS-gel were leveraged to create a library of materials by varying the compositions of the pro-slide-ring crosslinkers and introducing different water-soluble co-monomers, such as dimethylacrylamide (DMA), hydroxyl ethylene acrylate with sodium acrylate (HEA/AANa), and HEMA (FIG. 6A). Hence, Applicant performed a high-throughput CrysDoS-gel synthesis (FIG. 6A) with varied PEG₄ₖ-(azo)₂ concentrations (8-17 mM), [γ-CD]/[PEG₄ₖ-(azo)₂] ratios (0-14), and co-monomers and [co-monomer]/[PEG₄ₖ-(azo)₂] ratios (100, 150). Additionally, a non-reactive PEG₄ₖ-(nap)₂ axle was used as a competing axle agent, which will only contribute to the formation of crystalline domains in the hydrogel but will not form slide-ring joints.

Stock solutions of the pro-slide-ring crosslinker components and co-monomers were mixed in multiple 48-well plates for gelation, followed by polymerization, generating a library of 96 CrysDoS-gels (FIG. 6B). Notably, the gelation time of these samples remained short (<1 min) with slight variations depending on the co-monomer selection and precursor concentrations.

To investigate the mechanical properties of these CrysDoS-gels in a time- and cost-effective manner, Applicant performed uniaxial compressive and cyclic (un)loading tests. These analyses yielded a comprehensive dataset encompassing experimental measurements of compressive moduli (E), compressive toughness (U), and mechanical hysteresis (1−U₂/U₁) for all 96 CrysDoS-gels. The library of CrysDoS-gels exhibited a broad range of mechanical features, with compressive moduli and toughness spanning two orders of magnitude (E=7.2 to 600 kPa, U=6.0 to 500 kJ/m³, FIG. 6B). The synthesized CrysDoS-gels were classified into three categories: soft and brittle, soft and tough, and rigid and tough. To illustrate each category, Applicant selected three representative CrysDoS-gels for further discussion (FIG. 6C).

In the soft and brittle category, exemplified by the CrysDoS_{(8, 32)-DMA}-gel synthesized at a low [γ-CD]/[PEG] ratio, the gel displayed a compressive modulus E=59 kPa and a strain-at-break σ_{break}=67% (FIG. 6D, black). This gel exhibited the typical behavior of a covalently crosslinked network with minimal hysteresis observed in the cyclic (un)loading test (FIG. 6C, black). Moving to the soft and tough category, when the [γ-CD]/[PEG] ratio was increased to 10, the CrysDoS_{(8, 80)-DMA}-gel showed enhanced compressibility of σ_{break}=91% while maintaining a similar compressive modulus E=101 kPa (FIG. 6C, blue). The third category was represented by the CrysDoS_{(17, 170)-DMA}-gel, which possesses a higher concentration of pro-slide-ring crosslinkers, resulting in a rigid and tough gel. The CrysDoS_{(17, 170)-DMA}-gel showed both a high compressive modulus of E=541 kPa and high compressibility σ_{break}>94% (FIG. 6C, red).

Furthermore, CrysDoS_{(8, 80)-DMA} and CrysDoS_{(17, 170)-DMA} hydrogels exhibited notable hysteresis with (1−U₂/U₁)=0.61 and 0.79, respectively (FIG. 6C, blue and red), suggesting that the hydrogen bonding between neighboring γ-CDs was disrupted upon compression to activate slide-ring motions. The remarkable combination of high compressive modulus and high toughness in the CrysDoS_{(17, 170)}-gel showcased the successful design of a crystalline-domain reinforced double-threaded slide-ring network, breaking the traditional trade-off between elasticity and toughness in slide-ring gels.

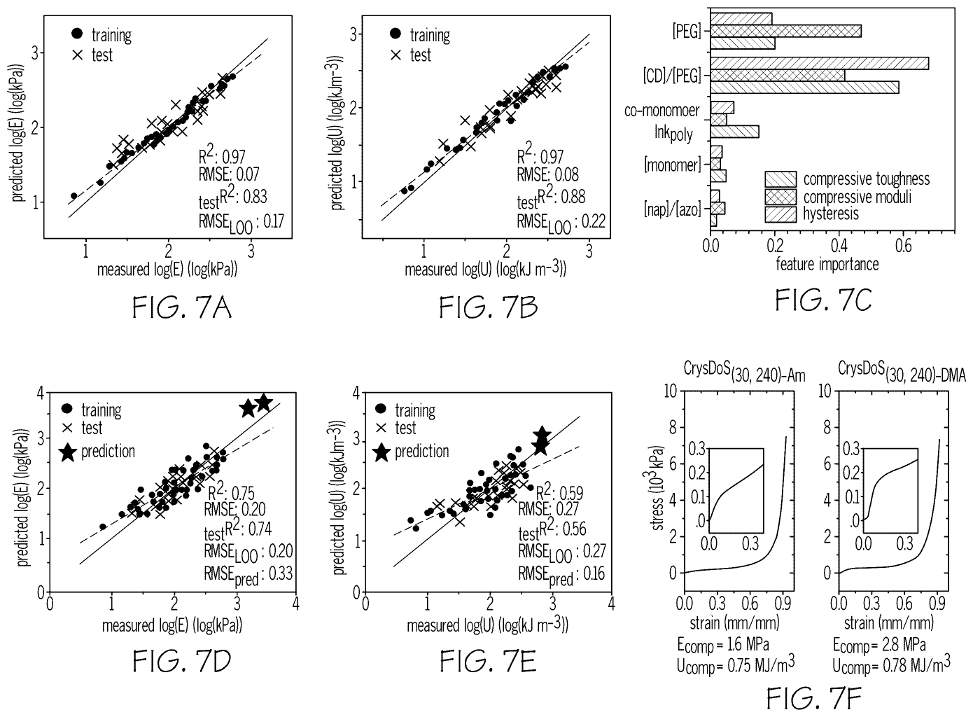

The high-throughput synthesis of CrysDoS-gels opened a large materials design space. However, the synthesis also introduced a complex structure-property relationship to interpret. Hence, data science tools such as random forest (machine learning) and multivariate linear regression analysis were employed to ascertain connections between the chemical composition of CrysDoS-gels and their materials properties (FIGS. 7A-7F). The chemical variables used to model the data set of 96 CrysDoS-gels consisted of PEG concentration, [γ-CD]/[PEG], types of monomers, [co-monomer]/[PEG], and [PEG₄ₖ-(nap)₂]/[PEG]. Separate models were created for each of the associated mechanical properties of the hydrogels, such as compressive moduli, compressive toughness, and hysteresis. The data set was partitioned into a training set (70% of the data) used to train each model and a test set (30%) that would be used to validate the predictive power of each model. Holding back 30% of the data during the model development in addition to other cross validation techniques such as leave-one-out (LOO) and k-fold (where k=5) were conducted to prevent overfitting and ensured that the models were not heavily biased toward specific data points over others.

A machine learning algorithm, random forest, was utilized to develop models for compressive moduli (FIG. 7A), toughness (FIG. 7B), and hysteresis of the CrysDoS-gels. These models were optimized using feature selection and hyperparameter optimization. The performance of the models was evaluated using the test set, which demonstrated a good fit with high R² values and the absence of significant outliers. Random forest analysis provided insights into the importance of different chemical features in relation to the mechanical properties (FIG. 7C). The composition of the pro-slide-ring crosslinker, which includes the PEG concentration and the ratio of [γ-CD]/[PEG], emerge prominently as the most influential features affecting the compressive moduli, toughness, and hysteresis of the synthesized CrysDoS-gels. In contrast, the rate of polymerization impacts the toughness more significantly than compressive moduli or hysteresis. Intriguingly, the addition of the competing PEG₄ₖ-(nap)₂ axle or the types of co-monomer had negligible contributions to the mechanical properties of the CrysDoS-gels.

While the random forest analysis highlighted the pro-slide-ring crosslinker as the primary contributor to the mechanical properties of the CrysDoS-gels, this algorithm is unable to predict data outside of the range it was trained on. Hence, multivariate linear regression analysis was performed to obtain a quantitative relationship between chemical features and mechanical properties, which allowed Applicant to extrapolate beyond the range of the data set and predict superior Crys-DoS-gels (FIGS. 7D-7E). Though these models are not as statistically powerful as the models obtained with random forest, the same key features representing pro-slide-ring crosslinkers and polymerization rates ([PEG], [γ-CD]/[PEG], and lnkpoiy) were identified as main contributors to the materials properties of CrysDoS-gels.

To validate the predictive power of these models, Applicant synthesized two gels, CrysDoS_{D(30, 300)-DMA} and CrysDoS_{(30, 240)-AM} (AM: acrylamide), with an increased amount of pro-slide-ring crosslinker and faster reacting co-monomers. The compressive moduli of CrysDoS_{D(30, 300)-DMA} and CrysDoS_{(30, 240)-AM} were measured as 2.8 MPa and 1.6 MPa, respectively (FIG. 7F). Their toughness was measured as 0.78 MJ/m³ and 0.75 MJ/m³, respectively (FIG. 7F). Both the compressive moduli and toughness of these two CrysDoS-gels outperformed the best hydrogels synthesized in the high-throughput experiments (Eₘₐₓ=0.6 MPa, Uₘₐₓ=0.5 MJ/m³). These discoveries not only verified the predictive power of the multivariate linear regression models, but more importantly, they demonstrated the feasibility to explore stronger CrysDoS-gels through the understanding of the structure-property relationship aided by data science.

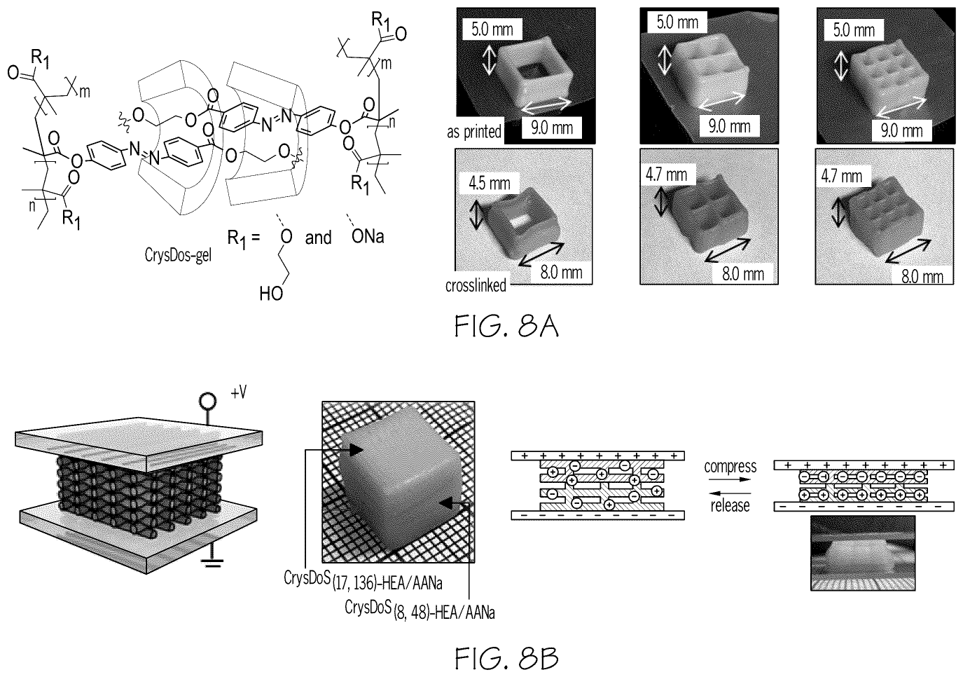

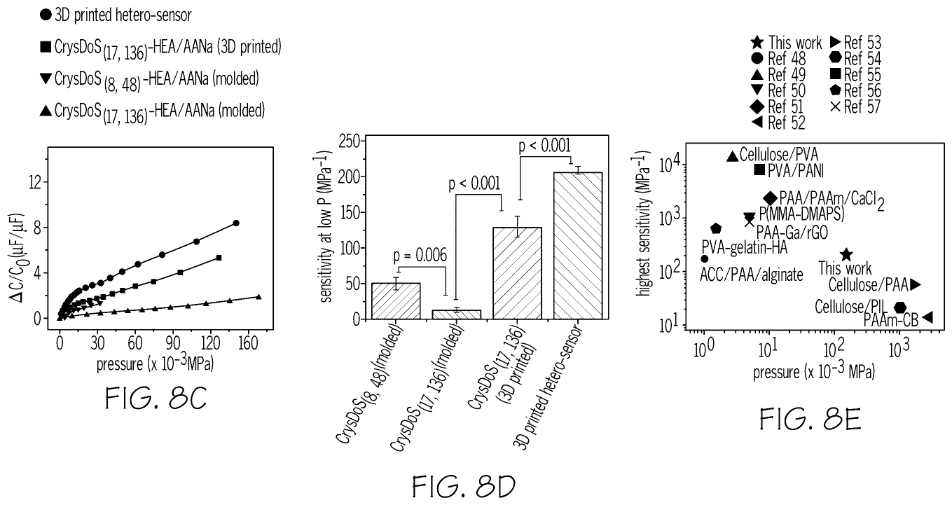

The broad range of the mechanical properties of the CrysDoS-gel library and their similar chemical compositions make them ideal for constructing stress-sensing devices with combined high sensitivity and large force detection range using DIW 3D-printing. The rapid gelation and excellent rheological features of the pro-slide-ring crosslinker PEG₄ₖ-(azo)₂/γ-CD hydrogels made them ideal for DIW. The PEG₄ₖ-(azo)₂/γ-CD polypseudorotaxane hydrogels in the presence of co-monomers were printed into woodpile lattice cubes with good structural integrity (FIG. 8A). They were converted to lattices of CrysDoS_{(15, 120)-HEA/AANa} after co-polymerization with good compressibility and rapid shape recovery.

To design a high-performance capacitive stress sensor, Applicant specifically selected CrysDoS_{(8, 48)-HEA/AANa} and CrysDoS_{(17, 136)-HEA/AANa}, with drastically different compressive moduli (24 and 263 kPa, respectively) from the library (FIG. 8B). These molded CrysDoS-gels showed a single linear response in terms of the relative capacitance change (ΔC/C₀) with respect to the applied stress. CrysDoS_{(8, 48)-HEA/AANa} exhibited a higher stress sensitivity (50±9 MPa⁻¹) but a lower range of detection (0-30 kPa). CrysDoS_{(17, 136)-HEA/AANa} showed a higher range of detection (0-150 kPa) but a reduced sensitivity (13±4 MPa⁻¹) (FIG. 8C).

While the rheological properties of the pro-slide-ring crosslinker for CrysDoS_{(8, 48)-HEA/AANa} gel only allowed for extrusion, CrysDoS_{(17, 136)-HEA/AANa}-gel was successfully 3D-printed as a self-supporting cube (9.0×9.0×10.8 mm). This cube showed a two-stage linear relationship and significantly improved its sensitivity at a lower pressure range (<10 kPa, FIG. 8C, black dot). The sensitivity of the first stage was measured to be 130±15 MPa⁻¹ (FIG. 8D), and the second stage was measured to be 30±10 MPa⁻¹. Applicant believes that the structural anisotropy and small voids introduced during the 3D-printing process enhanced its sensitivity without compromising its range of detection (FIG. 8D).

When a heterogeneous 3D-printed cube (9.0×9.0×10.8 mm) was constructed using the extrudable CrysDoS_{(8, 48)-HEA/AANa} and 3D-printable CrysDoS_{(17, 136)-HEA/AANa}, the sandwich-structured sensor showed a similar two-stage linear relationship (FIG. 8C, red dot), exhibiting further enhanced stress sensitivity of 209±5 MPa⁻¹ at the first stage (FIG. 8D) and a comparable sensitivity of 37±9 MPa⁻¹ to 3D-printed CrysDoS_{(17, 136)-HEA/AANa} at the second stage. The combined high sensitivity and range of detection of this heterogeneous stress sensor outperforms other state-of-the-art hydrogel materials (FIG. 8E). Clearly, the integration of compositionally similar but mechanically distinctive CrysDoS-gels through 3D printing overcame the trade-off between sensitivity and range of detection in traditional stress sensor designs, which will enable their potential applications for monitoring physiological signals, detecting environmental changes, or controlling robotic devices.

In summary, Applicant introduced a new strategy to overcome the elasticity-toughness trade-off in traditional slide-ring network design by introducing crystalline domain-reinforced double-threaded slide-ring networks. The key building block in this design is the pro-slide-ring crosslinker, formed through the self-assembly of γ-CDs and telechelic PEGs. Applicant discovered that the rapid self-assembly between the acrylate-azobenzenyl end groups of the PEG not only facilitates rapid gelation but also controls the number of threaded γ-CDs on the PEG through kinetic crystallization. These pro-slide-ring crosslinkers exhibit desirable viscoelastic properties for DIW 3D-printing due to the presence of micro-crystalline γ-CD/end-group domains.

By co-polymerizing the modular pro-slide-ring crosslinkers with water-soluble co-monomers, 3D-printable crystalline domain-reinforced slide-ring hydrogels were synthesized with high elastic moduli and toughness, surpassing the limitations in traditional slide-ring gels. Furthermore, the modular synthesis enabled a high-throughput discovery of double-threaded slide-ring hydrogels, leading to the construction of a library of 96 hydrogels with diverse mechanical properties.

Leveraging data science tools such as random forest and multivariate linear regression analysis, Applicant has established a clear structure-property relationship, identifying the composition of the pro-slide-ring crosslinker as the key determinant of compressive moduli, compressive toughness, and hysteresis in the hydrogels. Applicant discovered two new slide-ring hydrogels with superior mechanical performance predicted by the linear regression model. Moreover, Applicant selected two hydrogels from this library and fabricated a heterogeneous capacitive stress sensor using DIW 3D-printing. This sensor demonstrated combined high stress sensitivity and broad detection range, outperforming the capabilities of most state-of-the-art hydrogel sensors.

Overall, Applicant's new synthetic approach for constructing robust slide-ring networks, combined with modular high-throughput synthesis, data science-aided establishment of structure-property relationships, and stress sensor fabrication, demonstrates the power of designing mechanically robust networks through molecular design. This approach holds great potential for accelerating the discovery of rigid and tough slide-ring networks.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. A rotaxane composition comprising:
a plurality of macrocyclic rings and a plurality of polymers,
wherein the polymers are covalently appended to one or more macrocycle-binding molecules,
wherein each of the plurality of macrocyclic rings comprises a cavity,
wherein the cavities of the plurality of macrocyclic rings are threaded onto the polymers,
wherein at least some of the threaded macrocyclic rings are individually threaded onto two polymers to form double-threaded macrocyclic rings,
wherein the double-threaded macrocyclic rings comprise a plurality of different segments, and
wherein the plurality of different segments associate with one another to form a crystalline network.

2. The composition of claim 1, wherein the macrocyclic rings comprise cyclodextrins selected from the group consisting of β-cyclodextrin (β-CD), γ-cyclodextrin (γ-CD), r-cyclodextrin (r-CD), derivatives thereof or combinations thereof.

3. The composition of claim 1, wherein the macrocyclic rings comprise γ-cyclodextrin (γ-CD).

4. The composition of claim 1, wherein the polymers are selected from the group consisting of nonionic amphiphilic polymers, polyethylene glycol (PEG), polyethylene oxide (PEO), telechelic polyethylene glycol, poly(propylene oxide), polyalkyl ethers, block copolymers thereof, or combinations thereof.

5. The composition of claim 1, wherein the polymers comprise polyethylene glycol (PEG).

6. The composition of claim 1, wherein the composition is in the form of hydrogels.

7. The composition of claim 1, wherein each segment comprises at least 3 macrocyclic rings.

8. The composition of claim 1, wherein the segments are associated with one another in a parallel direction.

9. The composition of claim 1, wherein the one or more macrocycle-binding molecules are selected from the group consisting of cycloalkanes, cyclohexanes, camphors, adamantanes, norbornanes, bornanes, azobenzene (azo), 4′-hydroxy azobenzene-4-carboxylic acid, stilbene, biphenyl, terphenyl, naphthalene (nap), derivatives thereof, or combinations thereof.

10. The composition of claim 1, wherein the polymers are appended to a plurality of macrocycle-binding molecules, and wherein the plurality of macrocycle-binding molecules are appended to the polymers such that the plurality of macrocyclic rings are between the plurality of macrocycle-binding molecules.

11. The composition of claim 1, wherein each end of the polymers are covalently appended to a macrocycle-binding molecule.

12. A sensor, wherein the sensor comprises a composition comprising:
a plurality of macrocyclic rings and a plurality of polymers,
wherein the polymers are covalently appended to one or more macrocycle-binding molecules,
wherein each of the plurality of macrocyclic rings comprises a cavity,
wherein the cavities of the plurality of macrocyclic rings are threaded onto the polymers,
wherein at least some of the threaded macrocyclic rings are individually threaded onto two polymers to form double-threaded macrocyclic rings,
wherein the double-threaded macrocyclic rings comprise a plurality of different segments, and
wherein the plurality of different segments associate with one another to form a crystalline network.

13. The sensor of claim 12, wherein the sensor comprises a stress sensor.

14. A method of manufacturing a three-dimensional structure, said method comprising:
applying a composition onto a surface, wherein the composition comprises:
a plurality of macrocyclic rings and a plurality of polymers,
wherein the polymers are covalently appended to one or more macrocycle-binding molecules,
wherein each of the plurality of macrocyclic rings comprises a cavity,
wherein the cavities of the plurality of macrocyclic rings are threaded onto the polymers,
wherein at least some of the threaded macrocyclic rings are individually threaded onto two polymers to form double-threaded macrocyclic rings,
wherein the double-threaded macrocyclic rings comprise a plurality of different segments, and
wherein the plurality of different segments associate with one another to form a crystalline network;
wherein the applying results in the formation of the three-dimensional structure on the surface.

15. The method of claim 14, wherein the applying occurs by additive manufacturing.

16. The method of claim 14, further comprising a step of covalently cross-linking the three-dimensional structure.

17. The method of claim 16, wherein the covalent cross-linking occurs by photo-irradiation.

18. The method of claim 16, wherein the covalent cross-linking occurs through the use of a ketoenamine-based cross-linker.

19. The method of claim 18, wherein the ketamine-based cross-linker is selected from the group consisting of 1,3,5-benzenetrialdehyde (BD), 1,3,5-triformylphloroglucinol (TP), or combinations thereof.

20. A method of forming a rotaxane composition, said method comprising:
covalently appending one or more macrocycle-binding molecules onto a plurality of polymers,
threading a plurality of macrocyclic rings onto the plurality of polymers,
wherein each of the plurality of macrocyclic rings comprises a cavity,
wherein the plurality of macrocyclic rings are threaded onto the polymers through the cavities,
wherein at least some of the threaded macrocyclic rings become individually threaded onto two polymers to form double-threaded macrocyclic rings,
wherein the double-threaded macrocyclic rings comprise a plurality of different segments, and
wherein the plurality of different segments associate with one another to form a crystalline network.

21. The method of claim 20, wherein the macrocyclic rings comprise cyclodextrins selected from the group consisting of β-cyclodextrin (β-CD), γ-cyclodextrin (γ-CD), r-cyclodextrin (r-CD), derivatives thereof or combinations thereof.

22. The method of claim 20, wherein the macrocyclic rings comprise γ-cyclodextrin (γ-CD).

23. The method of claim 20, wherein the polymers are selected from the group consisting of nonionic amphiphilic polymers, polyethylene glycol (PEG), polyethylene oxide (PEO), telechelic polyethylene glycol, poly(propylene oxide), polyalkyl ethers, block copolymers thereof, or combinations thereof.

24. The method of claim 20, wherein the one or more macrocycle-binding molecules are selected from the group consisting of cycloalkanes, cyclohexanes, camphors, adamantanes, norbornanes, bornanes, azobenzene (azo), 4′-hydroxy azobenzene-4-carboxylic acid, stilbene, biphenyl, terphenyl, naphthalene (nap), derivatives thereof, or combinations thereof.

25. The method of claim 20, wherein the polymers become appended to a single macrocycle-binding molecule.

26. The method of claim 20, wherein the polymers become appended to a plurality of macrocycle-binding molecules.

27. The method of claim 26, wherein the plurality of macrocycle-binding molecules become appended to the polymers such that the plurality of macrocyclic rings are between the plurality of macrocycle-binding molecules.

28. The method of claim 26, wherein each end of the polymers become covalently appended to a macrocycle-binding molecule.
